(19) United States
(12) Patent Application Publication
(10) Pub. No.: US 2009/0121472 A1
(43) Pub. Date: May 14, 2009

(54) UV-Visible-IR Multi-Wave Length Laser Marking Process

(75) Inventor: Robert D. Battis, Skillman, NJ (US)

Correspondence Address: FOX ROTHSCHILD LLP, P O BOX 592, 112 NASSAU STREET, PRINCETON, NJ, 08542-0592, US

(73) Assignee: LASER ENERGETICS, INC., Mercerville, NJ (US)

(21) Appl. No.: 11/912,246

(22) PCT Filed: Apr. 21, 2006
(86) PCT No.: PCT/US2006/015339

§ 371 Date: Oct. 22, 2007

Related U.S. Application Data
(60) Provisional application No. 60/673,548, filed on Apr. 21, 2005.

(51) Int. Cl. B42D 15/10; B41J 2/455

(52) U.S. Cl. 283/85; 283/67; 347/224; 347/238

(57) ABSTRACT

An anti-counterfeiting method and apparatus causes a first mark to be produced on an object such as a pill in a package and then causes a second mark to be produced on said object while also producing said second mark on the plastic package cover over said object. A first laser beam producing means produces a first laser beam, preferably in the IR spectrum, and produces said first mark on the object when the beam passes through said cover. A second laser beam producing means produces a second laser beam preferably in the UV spectrum. The second laser beam also passes through said cover and produces said second mark superimposed on said first mark on said object. The second mark is always different from said first mark. Continued passing of said second beam through said cover causes said cover cloud up and form said second mark on said cover also. Accordingly, it is possible to determine if said object is in its original packaging by comparing the second mark on the object with the mark on the plastic cover and, if the objects are separated from their original packaging, when and where the object was made from the information embedded in said second mark on said object.

### CROSS REFERENCE TO RELATED APPLICATIONS

This application claims the priority of provisional U.S. Application Ser. No. 60/673,548, filed on Apr. 21, 2005 and entitled “UV-Visible-IR Multi-Wave Length Laser Marking Process” by Robert D. Battis, the entire contents and substance of which are hereby incorporated in total by reference.

### BACKGROUND OF THE INVENTION

1. Field of the Invention

The invention relates to a method and apparatus for marking an object, such as a pill, in situ, in a package and then applying a corresponding fiducial mark on the package that matches the pill itself in order to prevent counterfeiting.

2. Background of the Invention

The counterfeiting of drugs, food items and other items protected in a plastic covered package is an increasingly common problem. Accordingly, a number of methods have been developed to mark pills or tablets with unique identifying numbers. Unfortunately those numbers can be counterfeited. What is desired is a method for marking a pill or tablet, in situ, in a package, in such a way that it can not be remarked and also in such a way that a corresponding identifier can be placed on the package itself tying the marked component and package together. It was in the context of the foregoing need that the present invention arose.

### SUMMARY OF THE INVENTION

According to a first embodiment, a laser beam producing means produces a first laser beam, preferably in the IR spectrum, which shines through the plastic cover over objects such as a pill or similar objects such as a food item, batteries, etc. The first laser beam marks the pill with a recognized symbol, such as a trademark. The laser beam producing means, or a second laser beam producing means, produces a second laser beam preferably in the UV spectrum. The second laser beam passes through the plastic cover and produces a second mark preferably superimposed upon the first mark. As the second beam continues to pass through the plastic, it solarizes (clouds over) the plastic, hence blocking further marking of the substrate instead initiating marking of the plastic cover. Because the plastic cover has solarized photochemical change—clouded up, under the influence of the intense ultra-violet radiation, it is not possible to shine more light through the cover and affect the two super-imposed marks.

According to an alternative embodiment of the invention, a single laser beam, preferably UV light, is first focused on the object itself, such as a pill, to produce the first mark. A second mark can also be produced on the pill using appropriate focusing and then the UV beam can be refocused onto the plastic cover to produce the second mark on the cover corresponding to the second mark on the pill. Simultaneously, the cover will cloud up providing protection against future counterfeiting.

In view of the foregoing, it is possible to determine if the marked pill is still in its original packaging by comparing the second marks on the object or pill with the mark on the cover and, if the objects are separated from their original packaging, when and where the pill is made from the information embedded in the second mark on the pill.

The invention may be further understood by reference to the following drawings.

### BRIEF DESCRIPTION OF THE DRAWINGS

FIG. 1 is a schematic diagram of the preferred embodiment of the invention.

FIGS. 2A-2D illustrates the various steps required to mark an object using the preferred embodiment of the invention as illustrated in FIG. 1.

FIG. 3 is a schematic diagram of a device for producing two (2) different laser beams in the UV and IR spectrum using a conductively air-cooled Alexandrite laser.

FIG. 4A illustrates a commercially available direct write marking system.

FIG. 4B illustrates a commercially available projection marking system.

FIG. 5 illustrates an alternative embodiment of the invention employing only a single UV beam which produces markings in a manner similar to that illustrated in steps 2A-2D.

### DETAILED DESCRIPTION OF THE PREFERRED EMBODIMENT

During the course of this description like numbers were used to identify like elements according to the different figures that illustrate the invention.

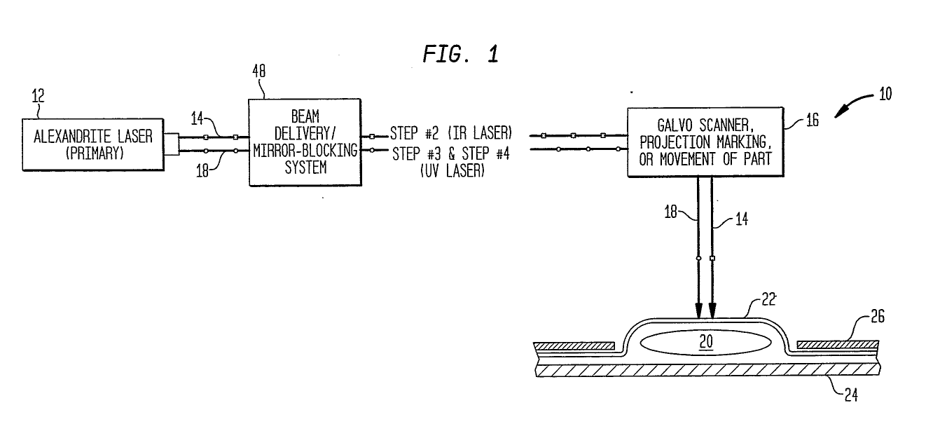

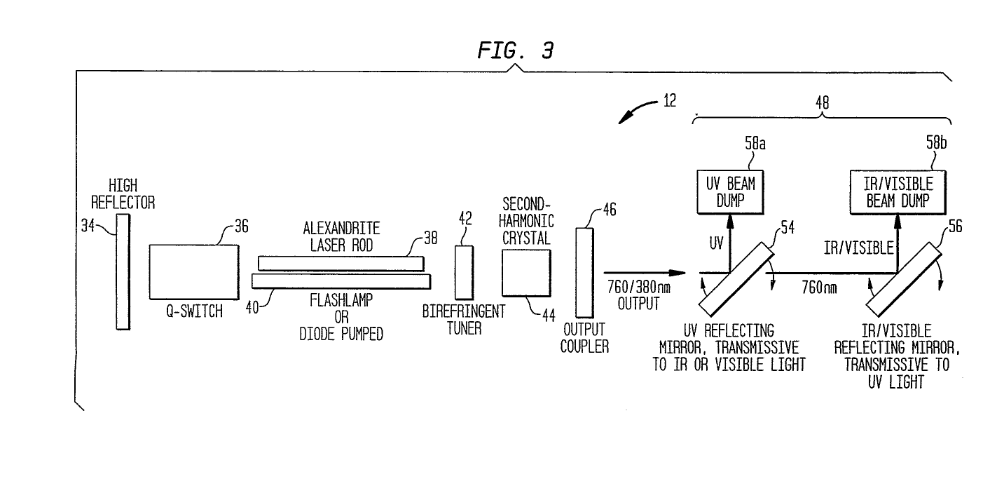

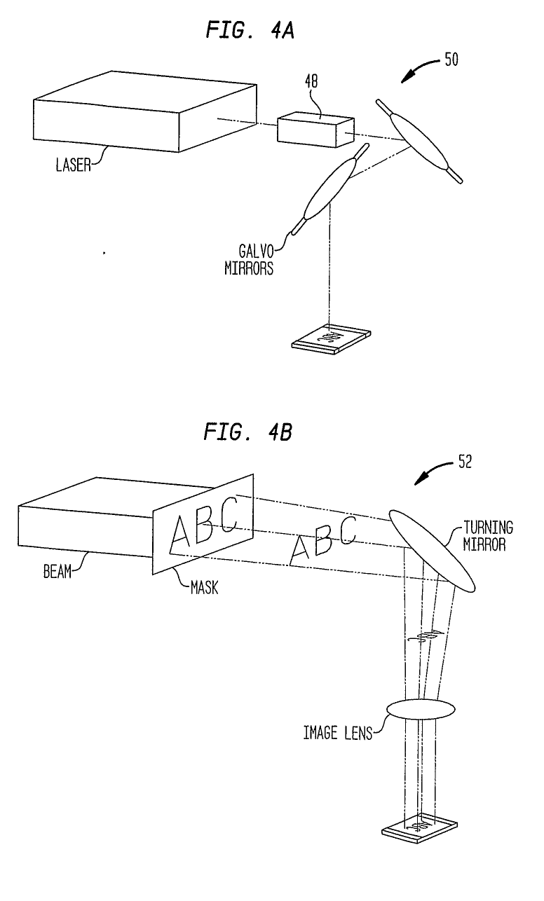

The preferred embodiment of the invention 10 is illustrated in FIG. 1. An Alexandrite laser 12, similar to that shown in FIG. 3, is employed as a laser beam source. Alexandrite laser 12 produces a first IR beam 14 having a wave length in the neighborhood of 760 nanometers and a second UV laser beam 18 having a wave length in the neighborhood of 380 nanometers. The first IR beam 14 has an acceptable range of 720-860 nanometers whereas the UV laser beam has an acceptable range of 360 to 430 nanometers. Both beams 14 and 18 are focused on either a galvo scanner or a projection marking device 16. Together the Alexandrite laser 12 and the galvo scanning device 16 comprise a commercially available direct write marking system 50 such as illustrated in FIG. 4A and as available as Model PSLM 1100 from Laser Energetics, Inc., 3535 Quaker Bridge Road, Suite 700, Mercerville, N.J. 08619. Alternatively, projection marking systems 52, such as that illustrated in FIG. 4B are also commercially available and useable and identified as Model PSLM 1000 also from Laser Energetics, Inc., Mercerville, N.J. As shown in FIG. 16 both beams 14 and 18 are directed downwardly towards an object 20 and its cover 22. According to the preferred embodiment, object 20 is preferably a medical pill, tablet or capsule or the like. It could, however, also comprise a food product such as candy or gum, or even hard items such as batteries. The object 20, in this case a pill, sits on a hard backing surface 24, preferably paper or plastic and is surrounded by a plastic cover 22. An upper layer of paper or cardboard 26 provides a window through which the plastic cover 22 projects. Plastic cover 22 is preferably a PET plastic well known in the medical packaging business. One of the characteristics of PET, and certain other plastics, is that they tend to solarize and lose their transparency when exposed to ultraviolet light, especially UV light emitted from laser that is quite intense. It is also possible to provide additives both in or on the plastic 22 and or coated on the plastic 22, to enhance its ability to absorb light (i.e. to photocolorize and solarize) under the influence of UV radiation.

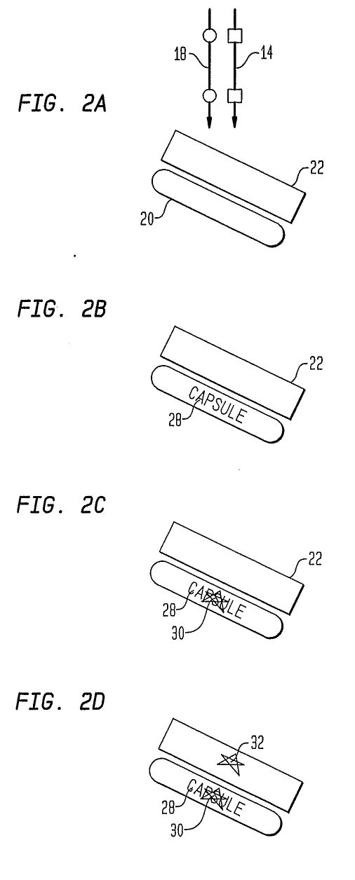

The steps of the preferred embodiment of the invention are illustrated in FIGS. 2A-2D. According to step number 1, the target or object 20, in this case a pill, is moved into position under the beam driving device 16. Plastic cover 22 is shown schematically superimposed over the target or object 20.

According to the second step illustrated in FIG. 2B, the IR laser beam 14 produces a first mark 28 illustrated by the word “CAPSULE” on the object 20. In all likelihood the first mark 28 would be a trademark, such as Tylenol®, which is a registered trademark of Johnson & Johnson, New Brunswick, N.J.

In the third, or next step, as shown in FIG. 2C, the UV beam 18 produces a second mark 30 superimposed on the first mark 28. The first mark might include a code that is cryptographically or stegnographical encoded in the design of the mark 30.

According to the fourth step of the invention as shown in FIG. 2D, the second mark is also applied to the cover 22 as mark 32. Marks 30 and 32 are identical. As the UV laser beam 18 passes through the cover 22, as shown in the third step of FIG. 2C, the cover 22 begins to solarize and become non-transparent and, accordingly, the energy of the UV laser 18 is then absorbed by the cover 22 forming the mark 32.

A typical conductively air-cooled Alexandrite laser system 12 is illustrated in FIG. 3. Such systems are commercially available as part of a direct write marking system 50 or projection marking system 52 illustrated in FIGS. 4A and 4B, respectively, as previously discussed. Such typical laser systems include a high reflector 34, a Q-switch system 36, the Alexandrite laser rod 38 itself, a flash lamp or diode pump 40, a birefrigent tuner 42, a second-harmonic crystal 44, an output coupler 46 and an optional fiber optic coupler 48. The beam Delivery-Mirror Blocking System 48 controls the IR 14 and UV 18 light which emits together and simultaneously from the Alexandrite laser 12 to control which light marks substrate, two mirrors (54, 56) coated to reflect and transmit IR 14 and UV 18 light are placed on electromechanical shutters. The first mirror 54 is coated to reflect UV 18 and transmit IR 14 laser light when in a closed position. The second mirror 56 is crafted to reflect IR 14 and transmit UV 18. IR 14 or UV 18 light when diverted, goes to the laser beam dumps 58a or 58b. If one is marking with IR 14 then mirror 54 is closed and mirror 56 is open. If one is marking with UV 18 then mirror 54 is open and mirror 56 is closed.

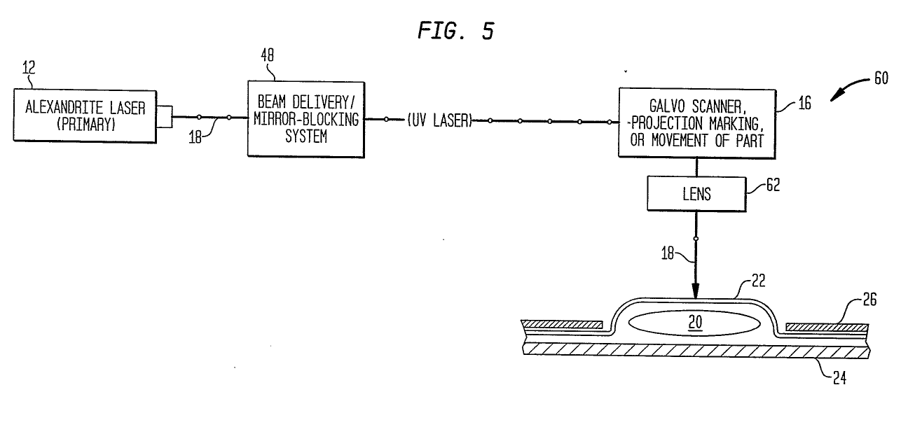

An alternative embodiment of the invention 60 is illustrated in FIG. 5. The primary Alexandrite laser 12, according to the second embodiment, only produces a single UV laser beam 18 which is projected through the beam delivery system 48 upon the galvo scanner or projection marking device 16. The device 16 drives the UV beam 18 through a lens system 62. The steps followed by the alternative embodiment 60 are essentially the same as those illustrated in FIGS. 2A-2D but operate as follows.

According to the first step, the pill 20 and cover 22 are moved into position under the scanning or projection marking device 16.

According to the second step, the UV beam 18 is focused by lens mechanism 62 through the plastic cover 22 so that it impinges only on the object 20 beneath it. In doing so it produces the first mark 28 such as that shown in FIG. 2B.

According to the third step, the lens system 62 focuses the UV beam 18 again on the object 22 to form the second mark 30 superimposed on the first mark 28.

Lastly, according to the fourth step, the lens system 62 focuses the UV beam just on the cover 22 so as to form the second mark 32 which is identical to the first mark 30.

The second alternative embodiment 60 is capable of effectively achieving the same result but using a single laser. On the other hand, it requires very careful and delicate focusing of the lens system 62 and might for that reason not be quite as robust as the preferred embodiment 10 illustrated in FIGS. 1-4B.

The preferred embodiment of the invention comprehends an Alexandrite laser because it produces a variety of IR and UV beams that are tunable and easy to use. There are, however, other acceptable lasers including, but not limited to, Nd:YAG, Excimer, Ti:SAF and CO₂ lasers.

The following is a table of acceptable laser pulse characteristics.

| | Primary | Primary | Primary IR-QS | Primary UV-QS |
|---|---|---|---|---|
| Laser Type | Wavelength - IR (nm) | Wavelength - UV (nm) | Pulse Width (ns) | Pulse Width (ns) |
| Alexandrite | 760 nm, | 380 nm, | 70-225 ns | 70-225 ns |
| | tunable 720-860 nm | Tunable 360 nm-430 nm | | |
| Nd:YAG | 1064 nm | 355 nm | 5-20 ns | 5-20 ns |
| Excimer | Not Available | 351, 308 nm | Not Available | 25-30 ns |

The projected average power according to the preferred embodiment is as follows:
1 mJ/pulse at 1 KHz=1 watt IR
0.4 mJ/pulse at 1 KHz=0.4. watts UV

Also, while IR is preferred for the first beam 14 it is also possible to use visible light in the 380-720 nm range.

Also, while the preferred embodiment of the invention contemplates the marking of a tablet, capsule or pill 20, it is clear that other items could be marked just as well such as candies, food products, gum, batteries, microelectronics, medical devices etc.

While the invention has been described with reference to the preferred embodiment thereof, it will be appreciated by those of ordinary skill in the art that various modifications can be made to the steps and parts of the basic invention without departing from the spirit and scope of the invention as a whole.

1. An anti-counterfeiting method of marking an object in a package including an at least partially transparent cover over said object, said method comprising the steps of:
a. passing a first laser beam having a first wavelength through said cover so that it produces a first mark on said object);
b. passing a second laser beam having a second wavelength different from said first wavelength through said cover so that it produces a second mark on said object different from said first mark; and,
c. continuing to pass said second laser beam through said cover thereby causing said cover to lose at least some of its transparency and also to form said second mark on said cover.

2. The method of claim 1 wherein said first laser beam is in the visible or IR spectrum.

3. The method of claim 2 wherein said second laser beam is in the UV spectrum.

4. The method of claim 3 wherein said cover is at least partially plastic.

5. The method of claim 4 wherein said object is selected from the group consisting of medicine pills, tablets, capsules, food, candy, gum products, batteries, microelectronics, and medical devices.

6. The method of claim 5 wherein said first and second marks on said object are superimposed over each other.

7. The method of claim 6 wherein said first laser beam has a wavelength in the range of 720-860 nm and said second laser beam has a wavelength in the range of 360-430 nm.

8. The package and object marked according to the process of claim 7.

9. An anti-counterfeiting apparatus for marking an object in a package including an at least partially transparent cover comprising:
a first laser beam producing means for producing a first laser beam having a first wavelength and for passing said first laser beam through said cover thereby producing a first mark on said object; and,
a second laser beam producing means for producing a second laser beam having a second wavelength, different from said first wavelength, and for passing said second laser beam through said cover thereby producing a second mark, different from said first mark, on said object and on said cover,
wherein said cover looses at least some of its transparency when exposed to said second laser beam.

10. The apparatus of claim 9 wherein said first laser beam is in the visible a IR spectrum.

11. The apparatus of claim 10 wherein said second laser beam is in the UV spectrum.

12. The apparatus of claim 11 wherein said cover is at least partially plastic.

13. The apparatus of claim 12 wherein said object is selected from the group consisting of medicine pills, tablets, capsules, food items, candy, gum products, batteries, microelectronics, and medical devices.

14. The apparatus of claim 13 wherein said first and second marks on said object are superimposed over each other.

15. The apparatus of claim 14 wherein said first laser beam has a wavelength in the range of 720-860 nm and said second laser beam has a wavelength in the range of 360-430 nm.

16. The package and object marked in accordance to the process of claim 15.

17. An anti-counterfeiting method of marking an object in a package including an at least partially transparent cover over said object, said method comprising the steps of:
a. focusing a UV laser beam through said cover onto said object so that it produces a first mark on said object;
b. focusing said UV laser beam through said cover onto said object so that it superimposes a second mark on said object different from said first mark; and,
c. focusing said UV laser beam onto said cover thereby causing said cover to lose at least some of its transparency and also to form said second mark on said cover.

18. An anti-counterfeiting apparatus for marking an object in a package including an at least partially transparent cover over said object, said apparatus comprising:
laser beam producing means for generating UV laser beam;
lens means for focusing said UV laser beam such that said UV laser beam forms a first mark on said object and then superimposes a second mark on said first mark and then focuses said UV beam on said cover to form a said second mark on said cover as said cover loses its transparency due to continued exposure to said UV beam.
